(19) United States
(12) Patent Application Publication
(10) Pub. No.: US 2025/0201243 A1
(43) Pub. Date: Jun. 19, 2025

(54) DEVICE AND METHOD FOR PERFORMING VOICE COMMAND BASED ON CONTROL AUTHORITY OF SEAT POSITION

(71) Applicants: HYUNDAI MOTOR COMPANY, Seoul (KR); KIA CORPORATION, Seoul (KR)

(72) Inventor: Seong Soo YAE, Hwaseong-si (KR)

(21) Appl. No.: 18/785,782

(22) Filed: Jul. 26, 2024

(30) Foreign Application Priority Data
Dec. 14, 2023 (KR) 10-2023-0181559

(51) Int. Cl. G10L 15/22

(52) U.S. Cl. CPC G10L 15/22; G10L 2015/223; G10L 2015/228

(57) ABSTRACT

A computer-implemented method for performing a voice command based on control authority by a seat position can include identifying a seat position of an occupant who has uttered a voice command, identifying an entity and an action from the voice command, determining a control authority assigned to the seat position of the occupant, and controlling the entity according to the action, in response to the determined control authority.

### CROSS REFERENCE TO RELATED APPLICATION

The present application is based on and claims the benefit of priority to Korean Patent Application Number 10-2023-0181559, filed on Dec. 14, 2023, in the Korean Intellectual Property Office, the entire disclosure of which is incorporated herein by reference.

### TECHNICAL FIELD

The present disclosure is related to a device and method for executing a voice command based on control authority of a seat position.

### BACKGROUND

Recent advancement in artificial intelligence have led to the widespread application of conversational systems, such as chat-bots and virtual assistants, across various fields. These systems facilitate natural language conversations with a user, requiring a deep understanding of user speech as input messages.

To achieve natural language understanding (NLU), conversational systems must grasp the current context of the conversation and infer the user's intent, analyzing input messages accordingly. The scope of speech recognition service has expanded into diverse domain including household and automotive applications.

For example, in automotive settings, voice commands generated by users are processed by speech recognition assistants and telematics services, enabling tasks like locking/unlocking doors and adjusting car temperature via voice commands. However, when multiple occupants are present in a vehicle, distinguishing between the control authority levels of the driver and passengers becomes crucial.

Allowing rear-seat passengers to control the driver's seat via voice commands could pose safety risks, while overly restricting passenger control authority may inconvenience both the driver and passengers. Thus, there is a need for research into methods for appropriately adjusting control authority based on vehicle occupant seat positions.

### SUMMARY

According to one aspect of the present disclosure, a computer-implemented method for executing a voice command based seat position control authority can include: identifying a seat position of an occupant who has uttered a voice command; identifying an entity and an action from the voice command; determining a control authority assigned to the seat position of the occupant; and controlling the entity according to the action, in response to the determined control authority.

According to another aspect of the present disclosure, a device for executing a voice command based on seat position control authority can include: at least one memory storing computer-executable instructions; and at least one processor. The at least one processor can be configured to execute the computer-executable instructions to perform operations comprising: identifying a seat position of an occupant who has uttered a voice command, identifying an entity and an action from the voice command, determining a control authority assigned to the seat position of the occupant, and controlling the entity according to the action, in response to the determined control authority.

### BRIEF DESCRIPTION OF THE DRAWINGS

FIG. 1 is a diagram illustrating an example of a situation in which a fellow passenger is giving a voice command.

FIG. 2 is a diagram illustrating an example of a device for performing a voice command.

FIG. 3 is a diagram illustrating an example of a seating arrangement and entity lists.

FIG. 4 is a diagram illustrating an example of a device for executing a voice command.

FIG. 5 is a diagram illustrating an example of a speech recognition system.

FIG. 6 is a flow chart illustrating an example of a method for performing a voice command.

### DETAILED DESCRIPTION

The present disclosure is directed to a device and method for performing a voice command based on control authority of a seat position, for the safety of a vehicle.

The present disclosure is also directed to a device and method for performing a voice command, capable of improving the convenience of passengers while promoting vehicle safety, by properly adjusting control authority assigned to a seat position.

Embodiments of the present disclosure are described below in detail using various drawings. It should be noted that when reference numerals are assigned to components in each drawing, the same components have the same reference numerals as much as possible, even if they are displayed on different drawings. Furthermore, in the description of the present disclosure, where it has been determined that a specific description of a related known configuration or function may obscure the gist of the disclosure, a detailed description thereof has been omitted.

In describing the components of the embodiments according to the present disclosure, symbols such as first, second, i), ii), a), and b) may be used. These symbols are only used to distinguish components from other components. The identity or sequence or order of the components is not limited by the symbols. In the specification, when a part “includes” or is “equipped with” an element, this means that the part may further include other elements, not excluding other elements unless explicitly stated to the contrary. Further, when an element in the written description and claims is described as being “for” performing or carry out a stated function, step, set of instructions, or the like, the element may also be considered as being “configured to” do so.

Each component of a device or method according to the present disclosure may be implemented in hardware or software, or in a combination of hardware and software. In addition, the functions of each component may be implemented in software. A microprocessor or processor may execute functions of the software corresponding to each component.

In the present disclosure, the term “entity” may be used interchangeably with the term “object.”

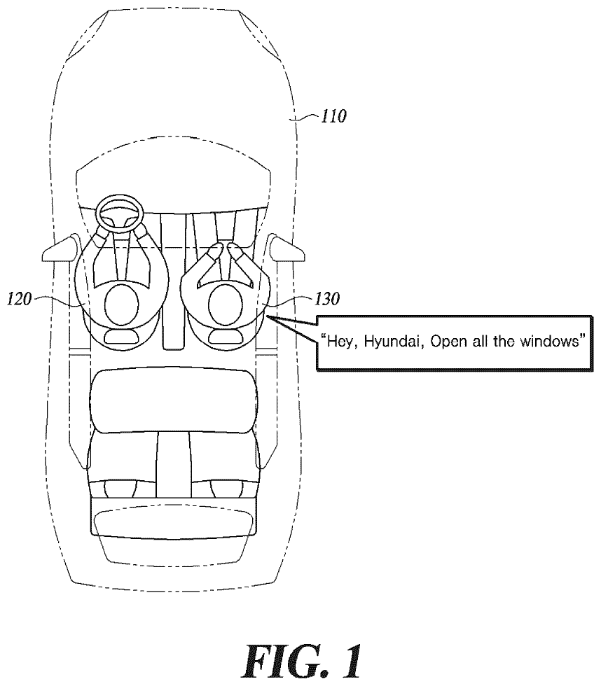

FIG. 1 is an exemplary view of a situation in which a fellow passenger is giving a voice command.

Referring to FIG. 1, a driver 120 and a fellow passenger 130 are in a vehicle 110.

For example, the fellow passenger 130 may utter a sentence saying “Hey, Hyundai, Open all the windows.” “Hey, Hyundai” may be a wake-up word for triggering speech recognition, and “Open all the windows” may be a voice command.

If the window near the driver 120's seat is opened by a voice command from the fellow passenger 130, the driver 120 may find it difficult to concentrate on driving. This may increase the possibility of the vehicle 110 getting into an accident.

Thus, each seat position in the vehicle 110 may require control authority settings.

In the vehicle 110, control authority settings can be configured for each seat position, and the control authority of a position from which a voice command is uttered is checked before the voice command is executed. For example, the seat position of the fellow passenger 130 may no have control authority over the window near the driver 120's seat. Thus, the vehicle 110 does not open the window near the driver 120's seat, regardless of the voice command from the fellow passenger 130. This may reduce the possibility of an accident.

In some implementations, if the seat position of the fellow passenger 120 has a low level of control authority, the driver 120 and the fellow passenger 130 may experience inconvenience. For example, even if the fellow passenger 130 utters “Hey, Hyundai, Open the trunk” when the driver 120 gets out of the vehicle and walks toward the trunk, the trunk may not be opened due to the low level of control authority the seat position of the fellow passenger 130 has.

However, in some implementations, the vehicle 110 can adjust the scope of control authority granted to the seat position of the fellow passenger 130. This would allow the driver 120 and the fellow passenger 130 to give a voice command.

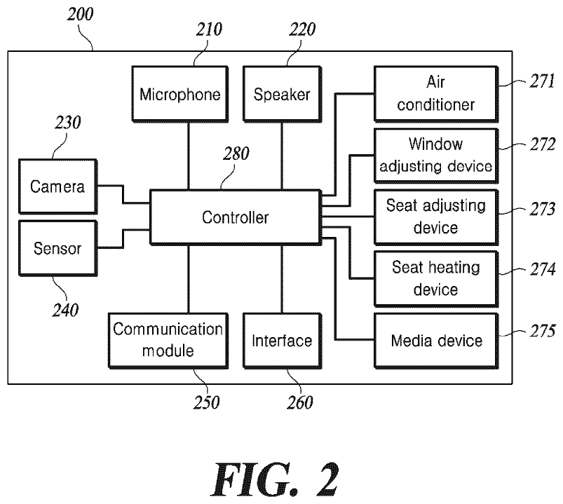

FIG. 2 is a diagram illustrating an example of a device for executing a voice command.

Referring to FIG. 2, the vehicle 200 can include a microphone 210 configured to receive a user's speech, a speaker 220 configured to output sound for providing a service requested by the user, a camera 230 configured to obtain images of the inside and outside of the vehicle, a sensor 240 configured to detect information on the inside and outside of the vehicle, a communication module 250 configured to perform communication with an external device, an interface 260 configured to input or output required to provide a service requested by the user, vehicle control components 271, 272, 273, 274, and 275, and a controller 280 configured to control the components of the vehicle 200.

The microphone 210 can be provided at a location in the vehicle 200 where a user's speech can be picked up. A user who gives voice input into the microphone 210 provided in the vehicle 200 may be an occupant indicating a driver or a passenger riding with the driver. The microphone 210 can be provided at a location where a steering wheel, a center fascia, a head lining, or a room mirror are positioned, to thereby receive a passenger's speech.

Moreover, two or more microphones may be provided to receive utterance from a rear seat occupant. A microphone 210 configured to receive speech from a rear seat occupant may be provided on a front-seat armrest or a rear-seat armrest, or on a rear-seat door, or on the B-pillar or C-pillar.

An audio signal inputted from the microphone 210 can be processed in the controller 280 or transmitted to an external server apparatus through the communication module 250.

The vehicle 200 can include an interface 260 configured to receive a user's command by a manual method such as touch, in addition to the microphone 210. The interface 260 can include an input device provided in the form of a button or a jog shuttle, in an area where the AVN of the center fascia is provided, in an area where the gearbox is provided, or on the steering wheel.

Moreover, the interface 260 can include an input device provided on the door of each seat or an input device provided on a front-seat armrest or a rear-seat armrest, in order to receive a control command at an occupant's seat position.

Furthermore, the input device can include a touch pad that is provided integrally with a display to implement a touchscreen.

The camera 230 can obtain at least one of an inside image or outside image of the vehicle 200. The camera 230 can be provided in such a way as to be directed toward the inside of the vehicle 200, or toward the outside of the vehicle 200.

The interface 260 can include an AVN display, a cluster display, or a head-up display (HUD). In addition or alternatively, the interface 260 can include a rear-seat display provided on the backside of the head of a front seat so that a fellow passenger in the rear seat views it, or, if the vehicle 200 is a high-occupancy vehicle, can include a display mounted on the head lining.

The display can be provided at any location and position as long as it can be viewed by a user riding in the vehicle 200, and there is no limitation on the number of displays or their positions.

The sensor 240 can detect various information on the vehicle.

The sensor 240 can include a pressure sensor configured to detect whether a seat is occupied, a touch sensor, a sensor configured to collect a biological signal, an infrared sensor configured to detect occupant behavior, an acceleration sensor related to the driving of the vehicle, a wheel rotation sensor, etc.

The communication module 250 can employ at least one of various wireless communication methods such as Bluetooth, 4G communication, 5G communication, and Wi-Fi to send and receive signals to and from other devices. In addition or alternatively, it is capable of sending and receiving information to and from other devices through a cable connected to a USB (universal serial bus) port, an auxiliary (AUX) port, etc.

Moreover, the communication module 250 can transmit and receive information and signals to and from two or more other devices by including two or more communication interfaces supporting different communication methods.

For example, the communication module 250 can communicate with a mobile device located inside the vehicle 200 via Bluetooth communication to receive information (a user's video, a user's speech, contact information, schedule, etc.) acquired by or stored in the mobile device, and can communicate with a server via 4G or 5G communication to deliver a user's speech and receive signals required to provide a service desired by the user. Also, it is capable of sending and receiving required signals to and from a server through a module device connected to the vehicle 200.

In some implementations, the vehicle 200 can include a navigation device for guiding directions, an air conditioner 271 for adjusting the internal temperature, a window adjusting device 272 for controlling opening/closing of a window, a seat adjusting device 273 for adjusting the position, height or angle of the seat, a seat heating device 274 for heating a seat, and a media device 275 for playing media or real-time streaming content.

The above-described devices provide convenience functions related to the vehicle 200, and some of the above-described devices may be omitted depending on the vehicle model and options and/or other devices may be further included in addition to the above-described devices. The configuration related to the travelling of the vehicle 200 is a well-known configuration, and thus descriptions thereof is omitted herein.

The controller 280 can control the components in the vehicle 200. The controller 280 can perform various controls related to the vehicle 200.

The controller 280 can control at least one of the air conditioner 271, the window adjusting device 272, the seat adjusting device 273, the seat heating device 274, the media device 275, or the navigation device, according to a user's command inputted through the microphone 210 or the interface 260.

Moreover, the controller 280 can turn on/off the microphone 210, and can process or store a speech inputted into the microphone 210 or deliver it to another device through the communication module 250.

Furthermore, the controller 280 can control an image to be displayed on the display and control audio to be outputted through the speaker 220.

For example, the controller 280 can perform a voice command based on control authority of a seat position.

Specifically, the controller 280 can pre-authorize control authority for seats within the vehicle 200. This the control authority may encompass information regarding control targets that can be controlled by a voice command inputted from a particular seat position.

Based on control authority of a seat position from which a voice command is uttered, the controller 280 can execute the voice command if the voice command is included in the control authority. In some implementations, if the voice command is beyond the control authority, the controller 280 can execute the voice command based on whether one or more conditions are met or not. If the conditions are not met, the controller 280 may ignore the voice command, or may execute the voice command upon approval from an occupant with the control authority.

The controller 280 may ignore voice commands that disrupt the driver or are not approved, and may perform voice commands that do not disrupt the driver or are approved by the driver, thereby ensuring safe driving of the vehicle 200 and improving the convenience of occupants.

The controller 280 can pre-store an entity list representing the control authority of each seat position.

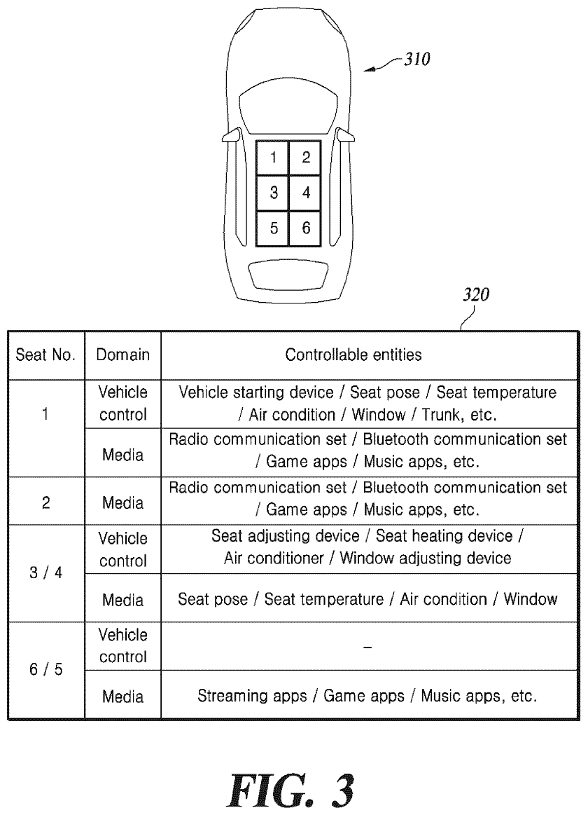

FIG. 3 is a diagram illustrating an example of a seating arrangement and entity lists.

Referring to FIG. 3, a seating arrangement 310 and an entity list 320 are depicted.

The seating arrangement 310 can include a total of six seat positions. The seat at the top left in the vehicle is Seat 1, and the seat at the bottom right in the vehicle is Seat 6. For example, Seat 1 may refer to the seat position of the driver, and Seats 2 to 6 may refer to the seat positions of passengers.

The seat adjusting device, the seat heating device, the air conditioner, the media device, or the window adjusting device may be provided at or near each seat. For example, a multimedia device of a head unit may be provided at Seats 1 and 2. RSE (rear seat entertainment) devices representing individually-operating entertainment systems may be provided at Seats 3 to 6.

The entity list 320 may refer to entities that are controllable at each seat position. For example, in the entity list 320, domains are configured for each seat, and controllable entities are configured for each domain.

For example, the occupant at Seat 1 may be able to control a vehicle control domain and a media domain via a voice command. Since Seat 1 is the driver's seat, various components of the vehicle, such as a vehicle starting, the seat pose, the seat temperature, the air condition, the window, a trunk, etc. can be controlled by a voice command inputted from Seat 1. Furthermore, radio communication set, Bluetooth communication set, game apps, or music apps in the media domain can be controlled by a voice command inputted from Seat 1.

In some examples, the occupant at Seat 3 may be able to control the seat pose, seat temperature, air condition, or window in the vehicle control domain via a voice command. However, since Seat 3 is not the driver's seat, Seat 3 does not have control authority over the vehicle starting device or the trunk control device. Thus, the occupant at Seat 3 is not able to control the vehicle starting device or the trunk control device. The control authority of Seat 3 can be adjusted upon approval from the occupant at Seat 1 or based on an unoccupied status of Seat 1.

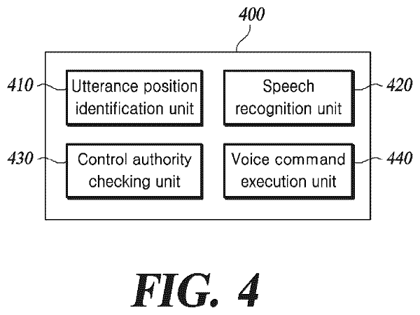

FIG. 4 is a diagram illustrating an example of a device for executing a voice command.

Referring to FIG. 4, the device 400 for executing a voice command can include an utterance position identification unit 410, a speech recognition unit 420, a control authority checking unit 430, and a voice command execution unit 440.

The device 400 can include at least one processor and a memory containing at least one command, and can perform the functions of the utterance position identification unit 410, the speech recognition unit 420, the control authority checking unit 430, and the voice command execution unit 440 by executing a command by the at least one processor.

Part of or the entire device 400 may be implemented by the controller 280 of the vehicle 200 in FIG. 2.

The utterance position identification unit 410 can receive a voice command from an occupant in the vehicle, and identify the seat position of the occupant who has uttered the voice command. For example, the utterance position identification unit 410 can identify a position from which the voice command is uttered.

The utterance position identification unit 410 can identify the seat position of the occupant who has uttered the voice command, based on at least one of sensors, microphone activation buttons or signal strengths of microphones at all seats.

For example, the utterance position identification unit 410 can identify whether a seat is occupied by an occupant, by using a sensor provided at each seat position. In some implementations, the sensor may be a pressure sensor or a distance sensor. Upon receiving a voice command while a seat is occupied, the utterance position identification unit 410 can determine that the voice command has been uttered from the occupied seat.

In some implementations, the utterance position identification unit 410 can identify the seat position of the occupant who has uttered the voice command, by using a microphone activation button provided at each seat position. When a certain microphone activation button goes to an on state just before receiving a voice command, it is determined that the voice command has been uttered from the seat position where the microphone activation button is provided. Here, the microphone activation button may represent a push-to-talk (PTT) button.

In some implementations, the utterance position identification unit 410 can identify the seat position of the occupant who has uttered the voice command, based on signal strengths inputted into the microphones in the vehicle. The utterance position identification unit 410 can determine that the voice command has been uttered from a seat position with a microphone into which a high-strength signal has been inputted.

The utterance position identification unit 410 can identify the position from which the voice command has been uttered, based on not the entire voice command but a wake-up word recognized from the voice command.

In some implementations, the speech recognition unit 420 can identify at least one of a domain, a control-entity, and a control-action from the voice command.

First, a plurality of domains, entities included in each domain, and actions of the entities may be pre-defined. A controlled entity may be denoted by a terminal service name.

A domain may refer to information for identifying the theme of a user utterance. The domains may be defined as various types such as a vehicle control domain, a media domain, a call domain, or a navigation domain. A controlled entity and a control action may refer to a target and an action of target to be controlled in each domain.

The speech recognition unit 420 can convert a voice command into text and identify at least one of a domain, an entity, and an action from the text. To this end, the speech recognition unit 420 may classify the domain and intent of the voice command. Here, the intent includes a controlled entity and a control action.

In some implementations, the speech recognition unit 420 may be implemented on an external server. The device 400 in the vehicle may send an audio signal from a microphone to the speech recognition unit 420 in the external server and receive a speech recognition result from the speech recognition unit 420.

For example, for a voice command saying “Open the window”, the speech recognition unit 420 recognizes the voice command and identifies “vehicle control”, “window”, and “open” as domain, controlled entity, and control action, respectively.

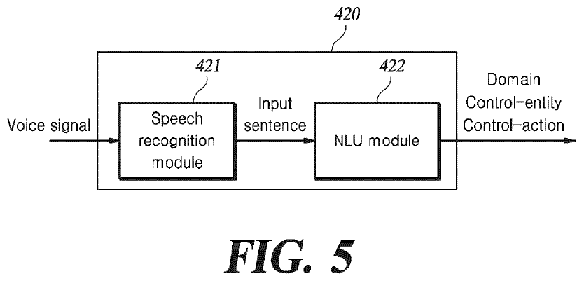

The speech recognition unit 420 will be described in detail with reference to FIG. 5.

The control authority checking unit 430 checks the control authority granted to the seat position of the occupant who has uttered the voice command.

The control authority checking unit 430 checks the control authority based on at least one of entities that are controllable from each seat position, a history of control at each seat position, whether a seat with the control authority is occupied, and approval from another occupant at the seat with the control authority.

Basic control authority is granted to each seat based on the entity list, and may be adjusted according to the control history, whether a seat with the control authority is occupied, and approval from another occupant.

In an example, an entity list recording entities that are controllable at each seat position is pre-stored. That is, the entities that are controllable vary depending on the seat position. The control authority checking unit 430 determines whether an entity identified by the speech recognition unit 420 is included in the controllable entity list for the seat position of the occupant who has uttered the voice command. If the identified entity is included in that controllable entity list, the control authority checking unit 430 determines that the seat position of the occupant has control authority over the controlled entity. In the above example, the control authority checking unit 430 may determine whether a window adjustment is included in the controllable entity list for that seat position.

In another example, the control authority checking unit 430 checks for a history of control at each seat position. The control history represents the history of when a seat position has been granted control, such as by another occupant's approval. If the seat position of the occupant who has uttered the voice command has ever controlled an entity not included in the controllable entity list, the control authority checking unit 430 determines that the seat position of the occupant has control authority over the entity. Thus, the control authority checking unit 430 may check whether the seat position of the occupant is granted the control authority over the entity, based on whether the seat position of the occupant has a history of control over the entity. Meanwhile, if the vehicle stops or the head unit shuts down, the history of control may be reset.

In another example, the control authority checking unit 430 may identify the seat position having control authority over the entity identified from the voice command, sense another occupant at the seat position, request approval for the control authority from the another occupant, and receive approval for the control authority. Upon receiving approval for the control authority from the another occupant, the control authority checking unit 430 determines that the seat position of the occupant has control authority over the entity. The control authority may be approved per domain or per controlled entity. The control authority checking unit 430 may recognize that a voice command inputted from a seat position having no control authority over voice commands is inputted from a seat position having control authority, and alter the position from which the voice command is uttered.

In another example, the control authority checking unit 430 identifies the seat position having control authority over the entity identified from the voice command. If the seat position having control authority over the entity is sensed as not occupied by another occupant, the control authority checking unit 430 may directly grant the control authority to the seat position of the occupant who has uttered the voice command.

In response to the checking of the control authority granted to the seat position of the occupant who has uttered the voice command, the voice command execution unit 440 controls the entity identified from the voice command according to the control action.

The voice command execution unit 440 may control an air conditioner, a window adjusting device, a seat adjusting device, a seat heating device, and a media device for playing media or real-time streaming content.

Through the above-described operation, the device 400 may perform a voice command based on the control authority of each seat position, thereby allowing the driver to concentrate on driving and allowing a passenger to assist the driver with the consent of the driver or enjoy their time.

In an example, while the driver's seat is not occupied and the vehicle is in a stopped condition, the device 400 immediately performs a voice command from an occupant. Even if the occupant's voice command is related to vehicle control, the device 400 may perform the voice command.

In another example, upon receiving a voice command related to vehicle control from a passenger's seat position while the driver's seat is occupied and the vehicle is driving, the device 400 checks for a history of control at the passenger's seat position, and if there is no history of control, asks the driver to approve the granting of the control authority to that seat position.

In another example, upon receiving a voice command related to vehicle control from a passenger's seat position when there is a history of approving the granting of the control authority to that seat position, while the driver's seat is occupied and the vehicle is driving, the device 400 may immediately perform the voice command. If there is a history of rejecting the granting of the control authority to that seat position, the device 400 does not perform the fellow passenger's voice command.

In another example, upon receiving a voice command related to vehicle control from a passenger's seat position when there is a history of authority approval, while the driver's seat is occupied and the vehicle is in a stopped condition, the device 400 may ask the driver to grant the control authority over the entity to the passenger's seat position.

Meanwhile, the control authority granted to the seat positions of occupants may be adjusted within a preset scope. In other words, the control authority over entities that might endanger the safety of the vehicle may be granted to the seat position of the driver alone.

FIG. 5 is a diagram illustrating an example of a speech recognition system.

Referring to FIG. 5, the speech recognition unit 420 recognizes and understands a user's utterance and provides a response corresponding to the user's utterance. In this disclosure, the user and the occupant represents a driver or a passenger.

To this end, the speech recognition unit 420 includes a speech recognition module 421 that converts the user's utterance and voice command into text, and a Natural Language Understanding (NLU) module 422 that determines what at least one of the user's domain, controlled entity, and control action is. The speech recognition unit 420 may further include a response generation module for performing a process for providing a response corresponding to the intention of the user's utterance, and a dialogue manager for generally managing dialogues between the speech recognition unit 420 and the user.

The speech recognition module 421 acquires a user's utterance received by a microphone in the vehicle, and converts the user's utterance into an input sentence by using at least one STT (speech-to-text) engine. The STT engine may apply a speech recognition algorithm or a deep learning model to a speech signal representing the user's utterance and convert the speech signal into text.

For example, the speech recognition module 421 may extract a feature vector from the user's utterance by applying a feature vector extraction technique such as Cepstrum, linear predictive coefficient (LPC), Mel Frequency Cepstral Coefficient (MFCC), or a filter bank energy.

The speech recognition module 421 may obtain a recognition result by comparing an extracted feature vector and a trained reference pattern. To this end, an acoustic model for comparing audio signal characteristics by modeling or a language model for modeling the linguistic order of words or syllables can be used.

The speech recognition module 421 is capable of converting a user utterance into an input sentence in text form, based on a machine learning or deep learning model.

The NLU module 422 classifies the domain, a control-entity and a control-action for an input sentence. The control-action represents utterance intention, and the control-entity represents a slot.

Here, the slot refers to a semantic entity required to provide a response according to the utterance intention. The slot may be pre-defined for each utterance intention. The role of the slot is determined by the utterance intention. In an input sentence “Give a direction to Yanghwa Bridge”, for example, “Yanghwa Bridge” serves as a point of interest, whereas, in an input sentence “Play Yanghwa Bridge”, “Yanghwa Bridge” serves as the title of a song.

In some implementations, the NLU module 422 can determine what a controlled entity and a control action in an input sentence are, by comparing set grammar and the input sentence. For example, if the set grammar is “Open the <Object>” and the input sentence is “Open the trunk”, the NLU module 422 may determine that the domain is “vehicle control”, the controlled entity is “trunk”, and the control action is “open.”

In some implementations, the NLU module 422 can determine what the domain, controlled entity, and control action for an input sentence from a user are, by using tokening, a deep learning model, etc.

Specifically, the NLU module 422 can split an input sentence into tokens that are morpheme-sized. In addition or alternatively, the NLU module 422 can tag each token with a part of speech.

The NLU module 422 may embed tokens in a vector space. Each token or a combination of tokens is converted into an embedding vector. To improve performance, sequence embedding, position embedding, etc. also may be performed.

The NLU module 422 determines what the utterance intention and slot of an input sentence are, by grouping embedding vectors or applying a first deep learning model or a second deep learning model to the embedding vectors. Here, the first deep learning model may be a recurrent neural network that is trained to classify the utterance intention in response to an input of embedding vectors. The second deep learning model may be a recurrent neural network that is trained to determine the slot in response to an input of embedding vectors.

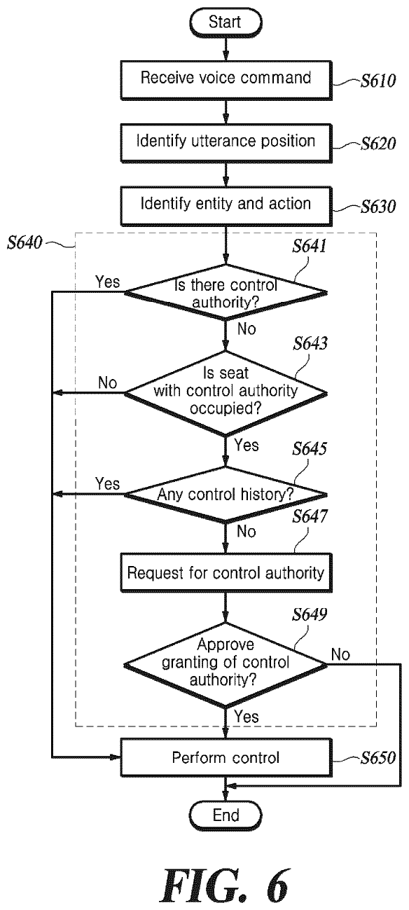

FIG. 6 is a flow chart illustrating an example of a method for executing a voice command.

Referring to FIG. 6, in the step S610, a device for executing a voice command can receive a voice command.

The voice command may include a wake-up word and expressions about a control request.

In the step S620, the device can identify a position from which the voice command is uttered.

Specifically, the device identifies the seat position of the occupant who has uttered the voice command. The device may identify the seat position of the occupant, based on at least one of sensors, microphone activation buttons, or signal strengths of the microphones at all seats.

In the step S630, the device can identify an entity and an action from the voice command. The device may identify the controlled entity and the control action through speech recognition. The entity represents a target to be controlled by the voice command.

In the step S640, the device can execute an authority authentication process for determining whether the seat position of the occupant who has uttered the voice command has control authority over the entity. Once the control authority is authenticated, the device controls the entity identified from the voice command in accordance with the control action in the step S650.

Specifically, in the step S641, the device can determine whether the seat position of the occupant who has uttered the voice command has control authority over the entity. Based on an entity list recording entities that are controllable at each seat position, the device determines whether the entity identified from the voice command is included in the controllable entity list for the seat position of the occupant who has uttered the voice command.

Once the control authority is checked, the device controls the entity identified from the voice command according to the action.

On the other hand, if the identified entity is not included in the controllable entity list, that is, the seat position of the occupant who has uttered the voice command has control authority over the entity, the device determines whether the seat position having control authority over the entity is occupied in step S643.

If the seat position having control authority over the entity is sensed as not occupied by another occupant, the device may directly grant the control authority to the seat position of the occupant who has uttered the voice command and control the entity in accordance with the action. By granting the authority by the device, the control authority of the seat position of the occupant who has uttered the voice command may be adjusted. For example, when the driver gets off the vehicle and walks toward the trunk, a passenger may control the trunk by uttering a voice command.

On the other hand, once the seat position having control authority over the entity is sensed as occupied by another occupant, the device determines whether the seat position of the occupant who has uttered the voice command has control history in the step S645. Specifically, the device determines whether the entity has ever been controlled by a voice command inputted at the seat position of the occupant who has uttered the voice command.

If there is a history of control, the device controls the entity in accordance with the action.

On the other hand, if there is no history of control, the device asks another occupant at seat position having control authority over the entity to grant the control authority in the step S647.

In the step S649, upon receiving approval for the entity and the action, the device can control the entity in accordance with the action.

On the other hand, if no approval is received for the entity and the action, the device does not control the entity.

Through the above-described process, the device may perform a voice command based on the control authority of each seat position, thereby allowing the driver to concentrate on driving and allowing a passenger to assist the driver with the consent of the driver or enjoy their time.

Meanwhile, the steps S641, S643, S645, S647, and S649 may be performed in different sequences.

As explained above, it is possible to perform a passenger's voice command while ensuring vehicle safety, by controlling the vehicle based on control authority of a seat position in the vehicle.

In some implementations, it is possible to improve vehicle safety and the convenience of passengers by properly adjusting control authority assigned to a seat position.

Various techniques described herein may be implemented in digital electronic circuitry, or in computer hardware, firmware, software, or combinations thereof. Implementations may be in the form of a computer program tangibly embodied in a computer program product, i.e., an information carrier, e.g., a machine-readable storage device (computer-readable medium) or a propagated signal, for processing by, or controlling, the operation of, a data processing device, e.g., a programmable processor, a computer, or a number of computers. A computer program, such as the above-mentioned computer program(s), may be written in any form of programming language, including compiled or interpreted languages and may be deployed in any form, including as a stand-alone program or as a module, component, subroutine, or other unit suitable for use in a computing environment. The computer program may be deployed to run on a single computer or multiple computers at one site or distributed across multiple sites and interconnected by a communications network.

In addition, components of the present disclosure may use an integrated circuit structure such as a memory, a processor, a logic circuit, a look-up table, and the like. These integrated circuit structures execute each of the functions described herein through the control of one or more microprocessors or other control devices. In addition, components of the present disclosure may be specifically implemented by a program or a portion of a code that includes one or more executable instructions for performing a specific logical function and is executed by one or more microprocessors or other control devices. In addition, components of the present disclosure may include or be implemented as a Central Processing Unit (CPU), a microprocessor, etc. that perform respective functions. In addition, components of the present disclosure may store instructions executed by one or more processors in one or more memories.

Processors suitable for processing computer programs include, by way of example, both general purpose and special purpose microprocessors, as well as one or more processors of any kind of digital computer. Generally, a processor will receive instructions and data from a read-only memory or a random access memory or both. The essential elements of a computer may include at least one processor that executes instructions and one or more memory devices that store instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include, by way of example, semiconductor memory devices, e.g., Magnetic Media such as hard disks, floppy disks, and magnetic tapes, Optical Media such as Compact Disk Read Only Memories (CD-ROMs) and Digital Video Disks (DVDs), Magneto-Optical Medial such as Floptical Disks, Rea Only Memories (ROMs), Random Access Memories (RAMs), flash memories, Erasable Programmable ROMs (EPROMs), Electrically Erasable Programmable ROMs (EEPROM), etc. The processor and the memory may be supplemented by, or incorporated in, special purpose logic circuitry.

The processor may execute an Operating System and software applications executed on the Operating System. Moreover, a processor device may access, store, manipulate, process, and generate data in response to software execution. For the sake of convenience, there is a case where a single processor device is used, but those skilled in the art will understand that the processor device can include multiple processing elements and/or multiple types of processing elements. For example, the processor device may include a plurality of processors or a single processor and a single controller. Other processing configurations, such as such as parallel processors, are also possible.

In addition, non-transitory computer-readable media may be any available media that can be accessed by a computer, and may include both computer storage media and transmission media.

Likewise, although the operations are depicted in the drawings in a particular order, it should not be understood that such operations must be performed in that particular order or sequential order shown to achieve the desirable result or that all the depicted operations should be performed. In certain cases, multitasking and parallel processing may be advantageous. Moreover, the separation of various device components of the above-described implementations should not be understood as requiring such separation in all implementations, and it should be understood that the described program components and devices can generally be integrated together in a single software product or packaged into multiple software products.

What is claimed is:

1. A computer-implemented method for executing a voice command based on seat position control authority, the method comprising:
identifying a seat position of an occupant who has uttered a voice command;
identifying an entity and an action from the voice command;
determining a control authority assigned to the seat position of the occupant; and
controlling the entity according to the action, in response to the determined control authority.

2. The method of claim 1, wherein identifying the seat position of the occupant includes identifying the seat position of the occupant based on at least one of a sensor, a microphone activation button, or a signal strength of a microphone.

3. The method of claim 1, wherein determining the control authority includes determining whether the entity is included in an entity list that stores one or more controllable entities at the seat position of the occupant.

4. The method of claim 3, wherein determining the control authority includes:
identifying, based on a determination that the entity is not included in the entity list, another seat position having control authority over the entity; and
receiving approval for the entity and the action from another occupant at the another seat position.

5. The method of claim 4, wherein determining the control authority further includes:
based on no other occupancy being detected at the another seat position, granting the control authority to the seat position of the occupant who has uttered the voice command.

6. The method of claim 1, wherein determining the control authority further includes determining the control authority based on whether the seat position of the occupant has a control history over the entity.

7. A device for executing a voice command based on seat position control authority, the device comprising:
at least one memory storing computer-executable instructions; and
at least one processor configured to execute the computer-executable instructions to perform operations comprising:
identifying a seat position of an occupant who has uttered a voice command,
identifying an entity and an action from the voice command,
determining a control authority assigned to the seat position of the occupant, and
controlling the entity according to the action, in response to the determined control authority.

8. The device of claim 7, wherein identifying the seat position comprises identifying the seat position of the occupant based on at least one of a sensor, a microphone activation button, or a signal strength of a microphone.

9. The device of claim 7, wherein determining the control authority comprises determining whether the entity is included in an entity list that stores one or more controllable entities at the seat position of the occupant.

10. The device of claim 9, wherein determining the control authority comprises:
identifying, based on a determination that the entity is not included in the entity list, another seat position having the control authority over the entity, and
receiving approval for the entity and the action from another occupant at the another seat position.

11. The device of claim 10, wherein determining the control authority comprises, based on no other occupancy being detected at the another seat position, granting the control authority to the seat position of the occupant who has uttered the voice command.

12. The device of claim 7, wherein determining the control authority comprises determining the control authority based on whether the seat position of the occupant has a control history over the entity.
